(19) United States
(12) Patent Application Publication
(10) Pub. No.: US 2006/0041517 A1
(43) Pub. Date: Feb. 23, 2006

(54) System, method and apparatus for exchanging currency, goods and services using a public network

(75) Inventor: Ju Wu Liao, Staten Island, NY (US)

Correspondence Address: JU WU LIAO, 1010 HYLAN BLVD, STATEN ISLAND, NY, 10305, US

(73) Assignee: Mydrew Inc., Dover (DE)

(21) Appl. No.: 11/206,310

(22) Filed: Aug. 17, 2005

Related U.S. Application Data
(60) Provisional application No. 60/602,614, filed on Aug. 19, 2004.

(51) Int. Cl. G06Q 99/00

(52) U.S. Cl. 705/80

(57) ABSTRACT

A system, method and apparatus where one party's item or plurality of items can be electronically exchanged for currency, goods and services or plurality of currency, goods and services of another party using a public network such as the internet. Users of the invention can create offers and make payment using currency, goods, services or a combination of currency, goods and services. A computer will store in a central database a list of items that are searchable to users of the system and items which are available for exchange. Users can store in a central database, items and services associated with the said user, to be available as a resource for an electronic exchange. The invention will provide the system, rules and processes in beginning, negotiating and completing an exchange. Invention will provide user interfaces, database search capabilities, user rating features and account management features to facilitate electronic exchanges.

This invention claims all the benefits of provisional patent application U.S. 60/602,614 filed on Aug. 19, 2004.

### BACKGROUND OF THE INVENTION

1. Field of the Invention

The present invention relates to the business of electronic commerce using an open communications network such as the Internet. Specifically, the invention relates to a system, method and apparatus to facilitate the exchange of a good or a service or a plurality of goods and services between two separate users over the Internet.

2. Description of the Background Art

The exchange of goods and services is one of fundamental human activities. From the first recordings of history, records have shown that the exchange of goods was fundamental to the progressive evolution of humankind. Our innate reliance on exchange and trade have not changed since the beginning of our evolution, however the systems, methods and apparatus that we utilize to facilitate an exchange has; The way humans exchange goods and services has evolved since the beginning of time, however even in today's world an exchange of goods and services can still mimic ancient methods juxtaposed modern methods and current technologies.

As technology changes and improves, so does our system and methods for exchanging goods and services. We have emerged from a central marketplace of a seller driven market, physically located in a specific geographical area, to a market that is exchange or system driven, where buyers and sellers can be located in physically disparate areas, exchanging goods and services through a virtual electronic market. The commonality between the markets of old and the markets of new is that both provide an area of congregation for buyers, sellers and traders to buy, sell, barter and trade goods or services, quickly and efficiently. This common foundation for establishing a simple exchange will forever be the same. As long as an efficient market can be created and maintained, human beings will continue to innovate, improve, acquire, develop and harvest all the benefits that their assets will allow them.

### DISADVANTAGES OF THE CURRENT METHOD

In today's times an individual who wants to buy, sell or trade goods or services has many options. Such options range from newspaper classifieds, online classifieds, online bulletin boards, online auctions, local flea markets, shopping malls, stores and businesses. Each option can provide an individual the desired outcome, but all have limitations in the way they can be efficiently utilized.

Newspapers provide an excellent outlet to reach prospective buyers. However, newspapers are seller driven marketplaces and sellers are limited to the number of readership of a particular newspaper. The method of newspaper classifieds would be for a seller to place an advertisement which contains seller contact information, to be used by buyers in order to complete a sale. Any communication between the buyer and seller must take place outside the venue of the newspaper classifieds; creating inefficiencies by increasing the time needed to complete a transaction.

The advent of the Internet has created new online virtual markets. Markets where an individual can buy, sell and trade from any location given there is an internet connection and a computer connected to the internet. Internet technology has created virtual markets based auctions, bulletin boards, classifieds and virtual storefronts. Leveraging the technology of an interconnected network each type of market provides individuals a venue where they can fulfill a common objective, improving their lives through buying, selling and trading goods and services.

Online auctions have proven to be very popular as a venue for online exchange. Auctions are seller driven marketplaces where buyers can bid against each other on a specific item usually in a finite period of time. Limitations of auctions are that bidding of an item must take place in a fixed time period. Fixed periods are necessary in order to close biddings and complete a transaction. There will be times when an audience bidding on an item may not be an optimal audience for a seller as well as times when the audiences may in fact create the best prices for a seller. Because auctions must occur over a fixed period of time, gathering the optimal audience to bid on items may not always occur. Also, since auction transactions are usually paid in currency, these auctions would be limited only to the currency that is available.

Electronic bulletin boards consist of a conglomerate of postings or advertisements, usually aggregated based on subject, location, title or other user defined category. Bulletin boards provide an individual the ability to place advertisements for an item which can be viewed by all users who read or subscribe to that specific bulletin. Online bulletin boards lack rules and processes in which transactions must take place, resulting in transactions that may be unstructured. The effect of this unstructured ness is that reliability as well as credibility is more difficult to achieve. The normal process of a bulletin board would be for a buyer to contact a seller using an alternative method such as electronic mail, telephone or fax in order to complete the transaction. Buyers must be knowledgeable about the purchase or subscribe to a specific bulletin board in order to discover items that are of value. The number of bulletin boards has greatly increased, making it difficult for sellers to broadcast their advertisement to the optimal target audience.

Virtual stores have been created allowing small businesses as well as large businesses to sell items to the online masses. The process of buying and selling in an online store mimics that of physical store, in that items are displayed by the seller, buyers can add items to a virtual shopping cart and check out when they are ready to pay; all as if they were in a physical store. The exchange that takes place in a virtual store always uses some form of currency as payment and would not provide a payment option using items such as goods and services. Sellers who utilize virtual stores are normally repeat sellers who carry a certain amount of inventory, one time sellers who may have a need to sell an item once may not utilize an online store, because the amount of resource needed to create such a venue would not warrant the return on the sale.

Online classifieds like their physical counterpart provide an excellent outlet to reach prospective buyers. Online classifieds provide a single virtual location where sellers can post an advertisement amongst a multitude of categories. The method to complete a transaction would be for a buyer to contact a seller using the contact information provided by the seller. Any communication or negotiations between the buyer and seller can take place outside the venue of the online classified, creating inefficiencies in the time it takes to complete a transaction.

Flea markets, shopping malls and stores are excellent venues to buy and sell goods or services. The major limitation of venues such as these would be that a person would need to physically be present in the geographic area where the market, mall or store is located in order to utilize or patronize its services. Other limitations include hours of operation of stores and businesses, proximity of the store or business to the area of residence, logistics in transportation to the store or business, shipping and handling of purchased items, and a finite number of stores and businesses accessible to any specific individual.

A marketplace, virtual or physical, can only be as efficient as the system, method and rules that members abide by in its use. For example, a market that allows only one trade per day would not be functional, a market that matches sellers who sell wheat too buyers who buy corn would also not be efficient. When a market is able to provide a set of rules in which all market participants' needs are fully satisfied, will there be full efficiency of a given marketplace. The needs and objectives of market participants will increase and vary in respect to the increase in number of participants for a given market. In order to achieve market efficiency, rules and methods created to ensure a safe and orderly market must allow market participants to satisfy their objectives without impeding on the efficiency and credibility of the market.

Any given market can provide a venue where a group of market participants can satisfy their objective, but at the same time many may alienate a group of potential market participants due to the fact that the said market is unable to satisfy market objectives for these participants. Reasons for market exclusion include but are not limited to issues such as closeness in proximity, entry costs of a market, pricing of goods and services, payment methods, risks involved in a transaction, economic factors and political factors. For all the reasons stated as well as reasons that are not stated, the exclusion of potential market participants to a particular market decreases the overall efficiency of achieving a totally efficient market.

There has always been a need to provide a market place that would allow the greatest number of participants, while reducing the barriers for participation for all potential market participants. Since the growth of the Internet there have been numerous newly created virtual markets that provide participants a venue to fulfill their market needs and objectives. Such virtual markets include online classifieds, online bulletin boards, online auctions and online stores. Each type of market has a set of participants whose objectives can be satisfied through their participation in a specific market venue. However, these said venues can greatly alienate numerous other potential participants due to the said reasons of market exclusion.

The exclusions created by these markets are defined by how these markets function, specifically the rules and methods these individual markets implement in their daily day to day operation. For example, online classifieds due to lack of individual virtual storefronts, may exclude market participants who need to sell large quantities of disparate items from a central virtual location. Online bulletin boards, which allow sellers to remain anonymous, may exclude market participants who seek a level of credibility or confidence when transacting with another participant. Online auctions, which accept payments using currency or cash, may exclude participants who need to make payments using goods and services in lieu of currency or cash. Online stores, due to the limitations in a stores' inventory, may exclude market participants who have a set of needs that are not satisfied using the inventories associated with an online store.

There exists a need to create a type of online marketplace where the system, methods and rules governing this marketplace, provide the greatest amount of market participation and at the same time reducing the barriers to participation, minimizing the reasons for exclusion and achieving a level of efficiency greater than what is currently available.

### SUMMARY OF THE INVENTION

The present invention consists of systems, methods, rules and apparatus providing an electronic marketplace for market participants over an electronic communications network such as the internet.

The said invention encompasses interfaces to provide a central virtual location for a user who has an internet connection and a computer to access the said internet connection, the said invention provides any user regardless of location, the ability to become market participant in an online marketplace using the said invention with minimal reasons for exclusion.

The methods comprises of maintaining a central database, where the said database contains personal data associated with users, financial data associated with users, product data associated with user inventory, rating data associated with users and transaction data associated with users. Product data will be searchable from the central database by users who satisfy a certain confidence level. Where as the confidence level can be set by the said user and the user associated with the product being searched. All users will have the capability to exchange electronic notes regarding the advertised product in order to determine the probability of engaging in negotiation with the user associated with the product. The said user will be able to engage in a set of actions, whereby choice of action determines the method of processing and type of negotiation which is to take place between the two users based on the rules of the invention.

According to an aspect of the invention, the method includes registering users as to collect personal, financial and shipping data from the prospective user.

According to an aspect of the invention, the method includes assigning unique identifiers to each registered user.

According to an aspect of the invention, the method includes the creation of product data by the said user to be saved in a central database associated with the said user.

According to an aspect of the invention, the method includes the organizing and displaying of electronic messages between two users in regards to a product associated with at least one of the users.

According to an aspect of the invention, the method includes the organizing and displaying of product data associated with the said user, to be used for the management of all user related product data.

According to an aspect of the invention, the said product created by the said user must be reviewed by a super user; wherein the super user review determines whether a product can be searchable in a central database by all users.

According to an aspect of the invention; the said super user can search the central database for product data not yet reviewed, modify and save product data associated with any user to a central database.

Users can choose to engage in a negotiation with another user associated with the advertised product. Depending on the saved product data, a potential buyer may be allowed to engage in the purchase of a product at a pre-determined price, a potential buyer may be allowed to engage in a offer for a product using a currency or cash as payment, so that the amount of the offer does not equal or exceed a predetermined price, or a potential buyer may be allowed to engage in an offer for a product using product data associated with the said buyer as a method of payment.

According to an aspect of the invention, the method includes the exchange of user information after the completion of transaction resulting from a purchase between the two users.

According to an aspect of the invention, the method includes a set of actions for a said user associated with a product to engage in upon receiving an offer from another user for the said product.

According to an aspect of the invention, the method includes the ability of a user associated with a product to decline an offer made by a potential buyer, causing electronic messages to be sent to both users specifying the decline of the offer.

According to an aspect of the invention, the method includes ability of a user associated with a product to accept an offer made by a potential buyer, causing electronic messages to be sent to both users specifying the acceptance of the offer.

According to an aspect of the invention, the method includes the ability of a potential buyer to begin a negotiation of an advertised product, using associated product data or plurality of associated product data saved in a central database, in which the said item or items are used as a method of payment.

According to an aspect of the invention, the method includes the completion of all open negotiations between a said user and all other users, who maintain open negotiations and are associated with the product in which an offer was made and accepted for.

### BRIEF DESCRIPTIONS OF THE DRAWINGS

FIG. 1.

High level view of overall system architecture.

FIG. 2.

Flow chart of registration process.

FIG. 3.

Flow chart for posting an advertisement to sell.

FIG. 4.

Flow chart for the approval of an advertisement by a super user.

FIG. 5.

Flow chart for searching a database and browsing available ads.

FIG. 6.

Flow chart for electronic message exchange between two users.

FIG. 7.

Flow chart for purchasing an advertised item.

FIG. 8a.

Flow chart for a currency denominated or cash offer.

FIG. 8b.

Flow chart for accepting or declining a currency denominated or cash offer.

FIG. 9a.

Flow chart for an exchange offer using goods or services.

FIG. 9b.

Flow chart for accepting or declining an exchange offer using goods or services.

FIG. 10.

Flow chart showing completion of a transaction.

FIG. 11.

Flow chart showing payment of fees

FIG. 12.

Mid level view of web architecture.

FIG. 13.

User interface for browsing exchangeable items.

FIG. 14.

User interface for browsing sellable items.

FIG. 15.

User interface for profile information.

FIG. 16.

User interface for electronic messages associated with purchases.

FIG. 17.

User interface for electronic messages associated with sales.

FIG. 18.

User interface for electronic messaging associated with exchanges.

FIG. 19.

User interface for buyer's want list.

FIG. 20.

User interface for inventorying sellable items.

FIG. 21.

User interface for posting an advertisement for sale.

FIG. 22.

User interface for trader's want list.

FIG. 23.

User interface for inventorying exchangeable items.

FIG. 24.

User interface for posting an advertisement for trade.

FIG. 25.

User interface for displaying a summary of offers.

FIG. 26.

User interface for displaying the details of an offer.

FIG. 27.

High level overview of ratings and history component.

FIG. 28.

User interface for inputting a rating.

FIG. 29.

Flow chart for processing a rating.

FIG. 30.

User interface for displaying rating information.

### DETAILED DESCRIPTIONS OF THE PREFERRED EMBODIMENTS

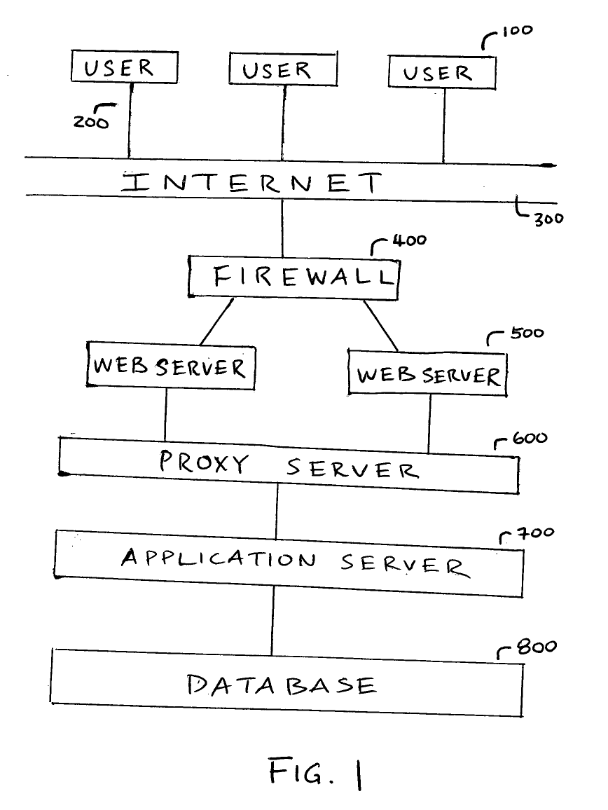

FIG. 1. details the overall architecture of the system. This invention provides two users, regardless of location the ability to transact over the internet using currency or goods and services as a payment method. [100] Users who are participants in this market will access the invention with a computer, in which the said computer contains internet browser software. The user must have a connection to the internet. The [200] said connection can be a dial-up, DSL, broadband, ISDN, T1, T2, T3 or OC connection. Users who access the system through the [300] internet will use the TCP/IP protocol as the protocol for internet communications. Other higher level protocols such as HTTP, HTTPS and FTP can also be used in order operate the system. Access to the system will be restricted by a [400] hardware firewall, where the said firewall shall be configured to allow all acceptable traffic to pass through while at the same time restricting all deniable traffic from entering. All incoming request will be processed by the [500] web server software which will reside behind the hardware firewall. Web server software can be configured as multiple instances, providing a level of fault tolerance and load balancing. There will exist a [600] proxy software layer that communicates and processes incoming requests from the web server layer. The proxy server software will determine the type of application service needed to process a request originating from the web server. Proxy software will direct the request to the proper application component in the next software layer, [700] the application server software. The application server software will provide all transaction processing for the incoming requests. The application software has access to a [800] database software where data can be saved for later retrieval and processing. Request from user containing sensitive information such as passwords, financial data and customer information will be transmitted securely using the SSL protocol using 128 bit public key encryption.

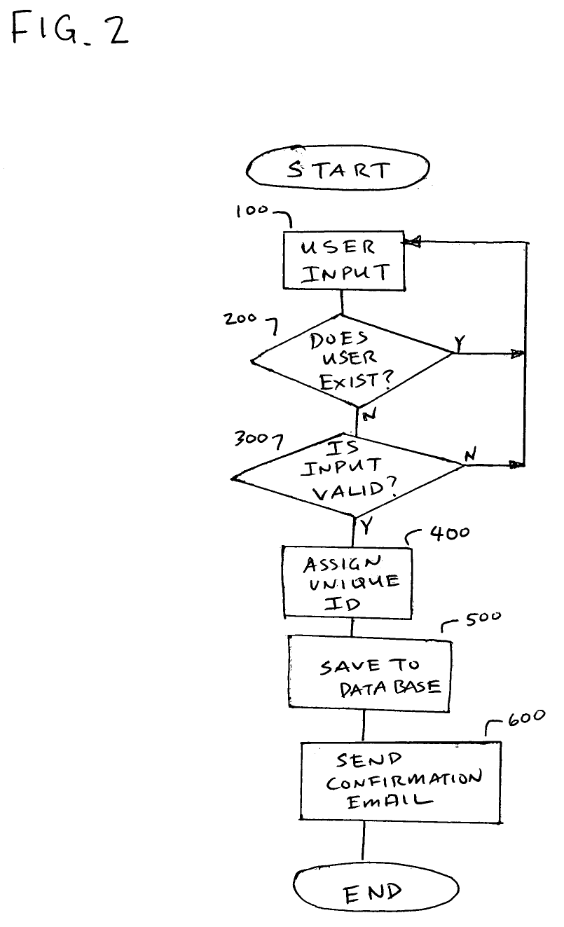

FIG. 2. details the capturing the input of a new user and registering that user to the system. [100] Using an interface accessible through browser software, new users are to input information associated with the said user. The information collected from a user include first name, last name, address, email address, a user selected member name and a user selected password. [300] All inputted information will be validated for correctness and consistency. [200] Email address and member name will be searched for in the central database to ensure non duplicity. If a member name or email address already exists in the central database, the user will be allowed to enter another email address or member name. [400] A unique identifier will be assigned to the validated user.

New entries will be added to database table. Entries pertaining to customer data, financial data, account data and transaction data will be added to the central database. [600] A confirmation email will be sent electronically to the email address inputted by the said user. Once the said user opens the sent confirmation email, the user data saved in the central database will be updated and the account would then be activated.

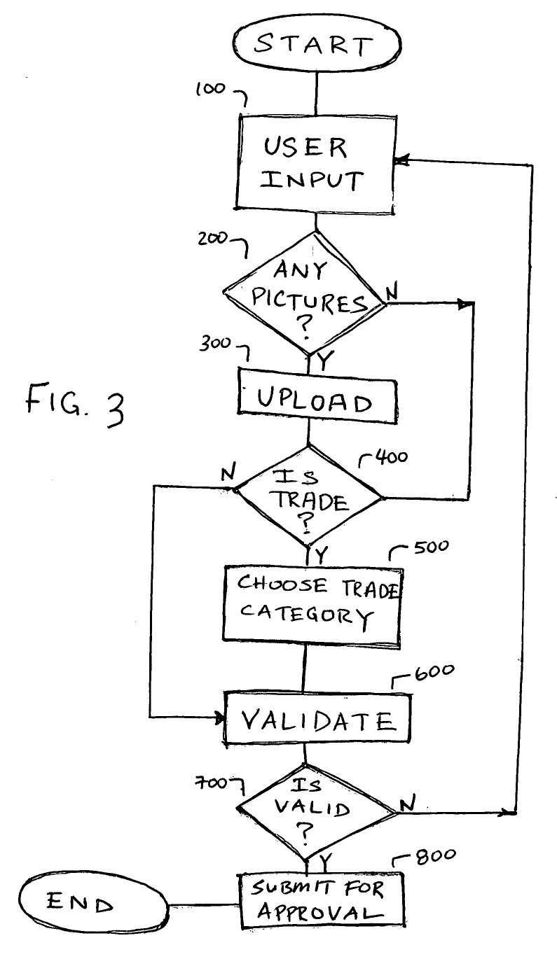

FIG. 3. details the capturing of data inputted by an activated user for the purpose of displaying an advertisement to be searchable by other activated users. [100] Using an interface accessible through browser software, the said user must choose a specific category that the advertisement will be assigned to. Data will be collected about the advertised item including quantity, size, location, title, description, photos, shipping information and tax rates. User must select whether the said item will be negotiable in price or fixed in price. Negotiable in price specifies that offers in currency can be made for this item. A fixed price indicates that users may only purchase the said item at the indicated price and no offers in currency will be allowed. User must select the trade type of the item. The trade type can be either a cash trade or an exchange trade or both. A cash trade specifies that the payment requested for an item must be made in currency or a currency related method. An exchange trade specifies that the payment requested for the item must be made using a good, service or plurality of goods and services. [200] User is allowed to upload photos that will be associated with the said advertised item. [300] Photos are required to be certain file types and be no more than a certain size. Photos uploaded will be stored in a temporary directory created using the user's member name. Thumbnails will be generated for the photos and added to the said directory. [400] If the item posted is an exchange trade, [500] the user must select at least one category from a list of categories in which the said user will accept payment in the form of good, services or plurality of goods and services from the selected category in exchange for the said advertised item. [600] Advertised item must be validated for correctness in input. If the pre-posted item is invalid, the user will be required to re-input data that were invalid. [700] Once the pre-posted item is validated, the item will be assigned a review status and the item will be saved in the central database.

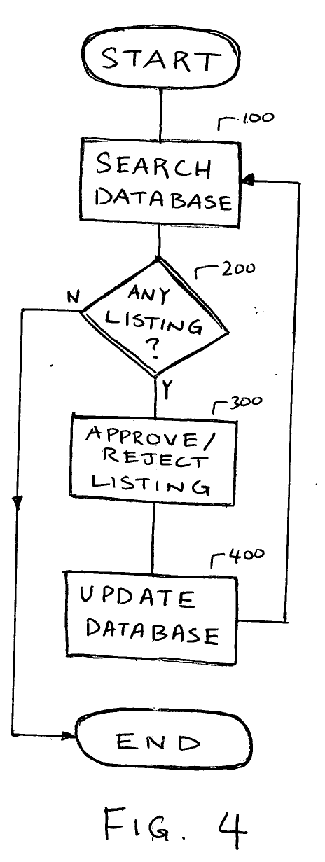

FIG. 4. details the process whereby a pre-posted advertisement is reviewed for compliance by a user, wherein the said user is a super user and has access privilege to the pre-posted advertisement. [100] A super user will search the central database for pre-posted advertisements that have been assigned a review status. The super user can begin a search using an interface accessible through browser software[200] If the search results in additional advertisements, the super user must set approve or decline status to each associated advertisement. [300] A status of approve will enable the advertisement to be searchable in the central database by other users. A status of decline will not enable the advertisement to be searchable in the central database by other users. [400] The central database will be updated to reflect the newly assigned status of each advertisement.

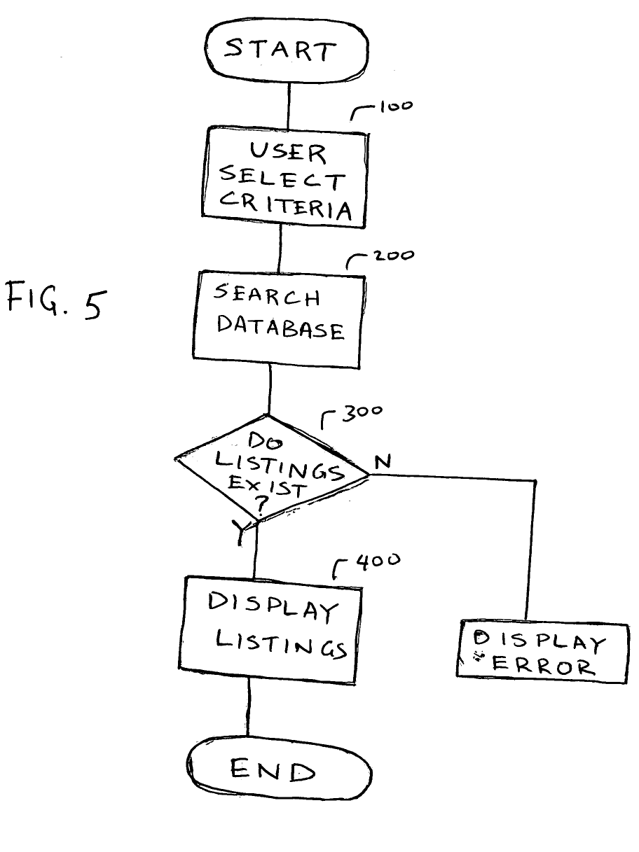

FIG. 5. details the process whereby a user searches a central database resulting in advertisements that satisfy the search criteria. [200] User can initiate a search for advertisements from the central database based on [100] criteria including category, advertisement owner, location, keywords, price, advertisement type or a combination of any of the said criteria. [300] Based on the results of the search, advertisements will be [400] displayed to the internet browser software if search results in one or more advertisements. [300] If search does not result in any advertisements, an error message will be displayed.

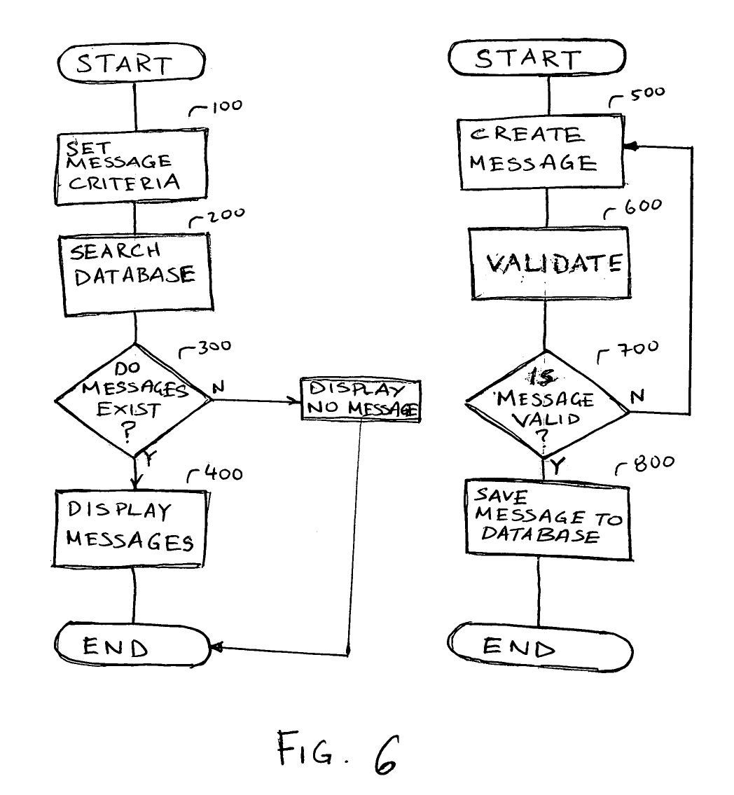

FIG. 6. details the process where electronic messages are created and retrieved. [100] A user sets the message type using an interface accessible via browser software, the said message type can be of type buy, sell or trade. [200] A search of the central database will be conducted using the message type and user data as criteria. [300] If search results in no returned messages, a pre formatted message will be displayed through the user interface. [400] If search results in one or more messages, the search result will be displayed in chronological order through a user interface displayed via browser software.

Messages are created by a user via inputting a text message using an interface displayed by browser software. [600] Once a message is created, the input text will be transmitted to the application server and validated for correctness. [700] If the message created is able to be validated, the associated message and user data will be saved to the central database to be retrieved and processed at a later time. If the message created is unable to be validated, the message data will be rejected and the user will be requested to reenter a valid message.

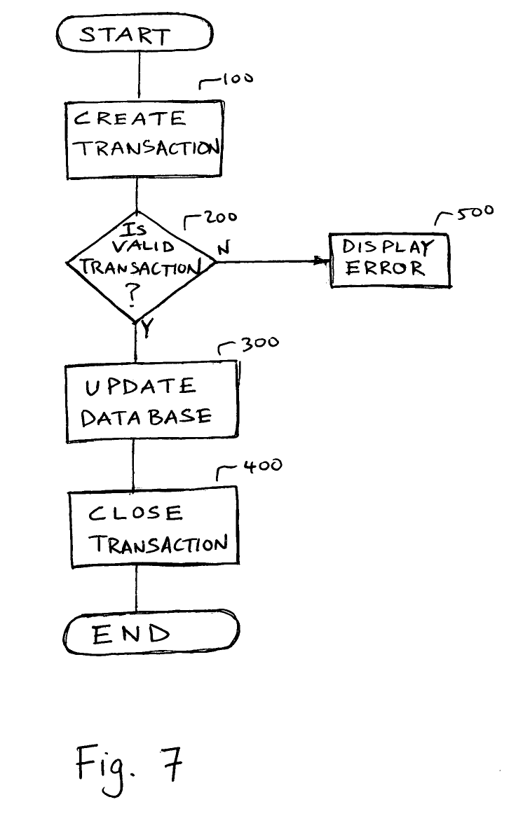

FIG. 7. details the process where a transaction is created and advertisement is purchased. [100] A user purchases an advertisement by clicking on the buy button. A new transaction is created with user data and item data. [200] The new transaction is validated for correctness. The user who is a buyer must not be associated with the advertisement. The user who is a buyer must have an associated account in good standing. The item being purchased must be available for purchase and the item being purchased must not be currently used as payment in a separate transaction. [500] If the transaction is not valid an error message will be displayed. [300] If the transaction is validated, transaction data will be saved to a central database. [400] All past open transactions where the purchased item is associated with a pending offer will be closed. Electronic messages will be sent to every user involved in the closed transaction. Electronic messages containing buyer and seller information and information confirming the purchase will be sent to both the user who is the buyer and the user who is the seller. Item that is sold will be updated so that it will not be searchable in the central database.

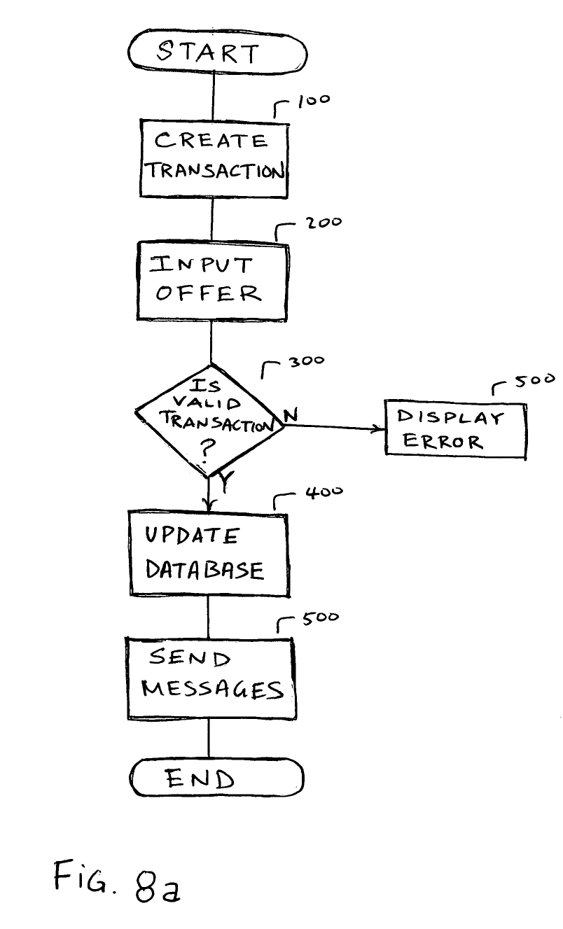

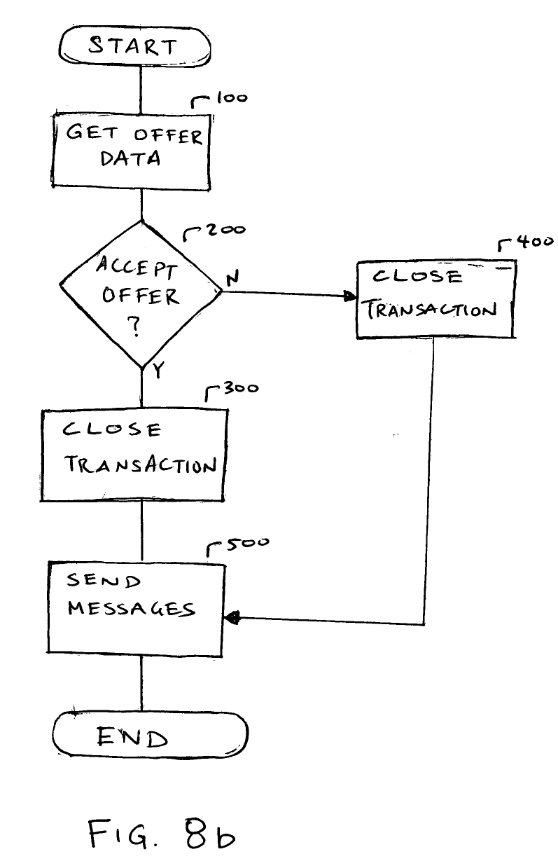

FIG. 8a. details the process where a transaction is created and a cash offer is made as payment for an advertised item. [100] A user who is a buyer makes a cash offer for an advertisement buy clicking on the offer button. [200] The buyer must input the amount in currency to be made as payment. A new transaction is created with user data and item data. [300] The new transaction is validated for correctness. The user who is a buyer must not be associated with the advertisement. The user who is a buyer must have an associated account in good standing. The item being purchased must be available for purchase and the item being purchased must not be currently used as payment in a separate transaction. [500] If transaction is not validated an error message will be displayed. [400] If the transaction is validated, transaction data will be saved to a central database. Electronic messages containing buyer and seller information and information associated with the offer will be sent to both the user who is the buyer and the user who is the seller.

FIG. 8b. details the process where an offer in currency is accepted or declined by a seller. [100] Offer data associated with an advertised item is displayed using browser software. [200] User has the option of accepting or declining the offer. Clicking on the accept button will accept the offer and close the transaction. [300] All past open transactions where the purchased item is associated with a pending offer will be closed. [500] Electronic messages will be sent to every user involved in the closed transaction. Electronic messages containing buyer and seller information and information confirming the purchase will be sent to both the user who is the buyer and the user who is the seller. Item that is sold will be updated so that it will not be searchable in the central database. [400] Clicking on the decline button will decline the offer from the associated buyer and close the transaction. [500] Electronic messages will be sent to both users involved in the closed transaction.

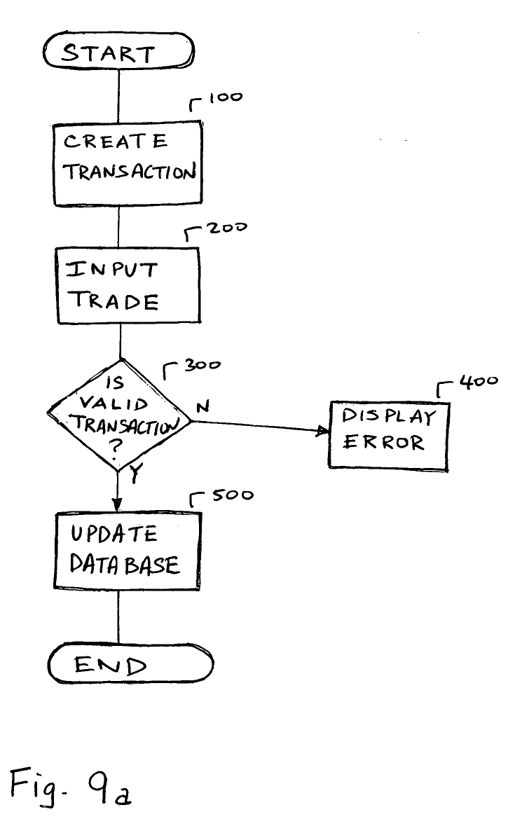

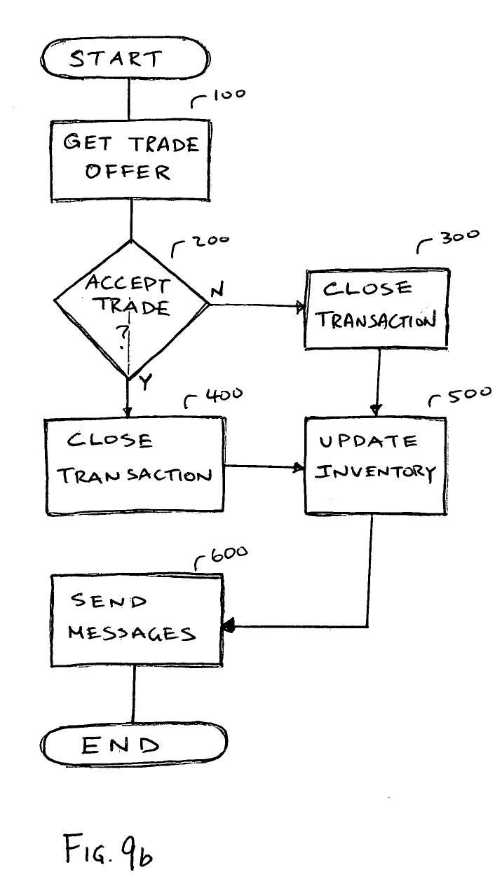

FIG. 9a. details the process where a transaction is created and an exchange offer is made as payment for an advertised item. [100] Using the interface displayed on the browser software a user is to click on the trade button which creates a new transaction. [200] User must select an item or items from the said user's trade inventory to be used in the offer for the payment of the advertised item. [300] The said trade offer will be validated for correctness. The user who creates a new transaction must not be associated with the advertised item. The said user must also have an associated account in good standing. The advertised item must be available for exchange and the item or items included in the offer must not be currently used in another offer in a separate transaction.

If transaction is not validated an error message will be displayed. [500] If the transaction is validated, transaction and offer data will be saved to a central database. Electronic messages containing user information and information associated with the offer will be sent to both the users of the transaction.

FIG. 9b. details the process where an offer for exchange is accepted or declined by the user associated with an advertised item. [100] Offer data associated with an advertised item is displayed using browser software. [200] User has the option of accepting or declining the offer for exchange. Clicking on the accept button will accept the offer and close the transaction. [300] All past open transactions where the advertised item is associated with a pending offer or offers, will be closed. All past open transactions where offered item or items associated with a pending offer or offers will be closed. [400] Clicking on the decline button will decline the offer and close the transaction. [500] Trading inventories will be updated to reflect the status of all items involved or affected by the offer. If the said offer is accepted, all items directly involved in the offer will be updated so as to be non-searchable from the central database. [600] Electronic messages will be sent to every user involved in the closed transactions. If the offer is accepted, electronic messages containing both user information and information confirming the exchange will be sent to both users.

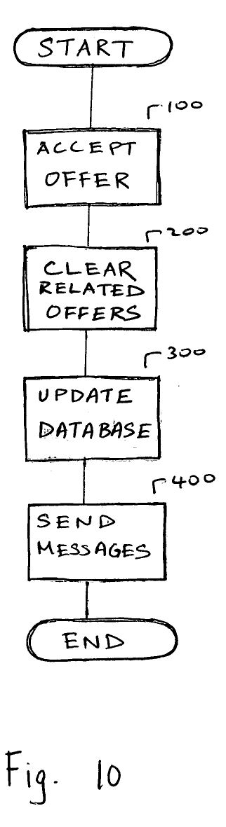

FIG. 10 details the process when a transaction has ended either through the acceptance or rejection of an offer by a user associated with an advertised item.

The offer must be accepted or rejected by clicking on the accept or reject button displayed in the interface using a browser software. [200] In a rejection transaction, [300] a currency offer is closed and [400] electronic messages are sent to both users. [200] In a rejection transaction, an exchange transaction is closed and [300] item or items used in the offer will be updated in the central database allowing the said item or items to be searchable. In an accepted transaction, [200] a currency offer is closed and all open offers associated with the advertised item will be closed, [300] the advertised item associated with the offer will be updated in the central database and be made non-searchable by other users, [400] electronic messages are sent to both users detailing the closed transactions. In an accepted transaction, [200] a exchange offer is closed and all open offers associated with the advertised item as well as the offered item or items will be closed, [300] the items directly associated with the said offer will be updated in the central database and be made non-searchable by other users, [400] electronic messages are sent to all users associated with a closed transactions, detailing information about the respective transactions.

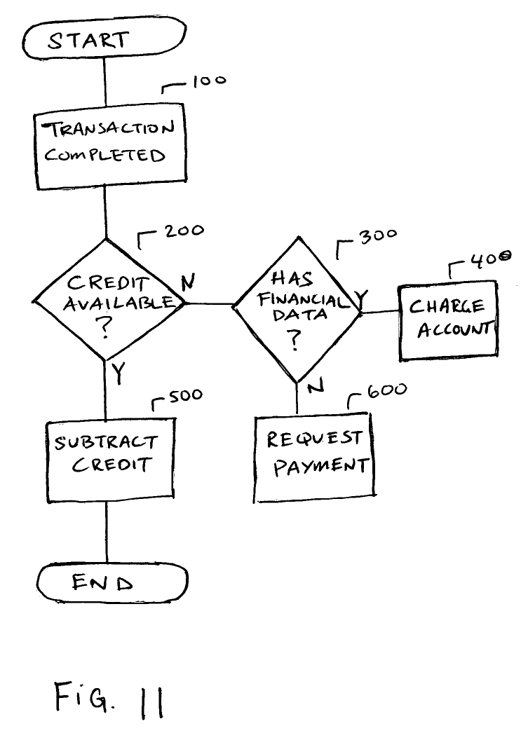

FIG. 11 details process of payment after a completed purchase or acceptance of an offer. [100] Transaction can be completed by the user clicking on the accept button or user clicking on a buy button. Buttons will be displayed on the interface through the browser software. [200] Check of account data is performed on the users whose advertised item was associated with the closed transaction. [500] If the said user has positive credits in the said account; credit will be deducted from the said account. [300] If the user does not have positive credit, a check will be performed on available financial information. [400] If financial information exists for this user, charge the fees using methods obtained from the financial information. [600] If no financial information exists for the user, a payment request will be sent electronically to the user.

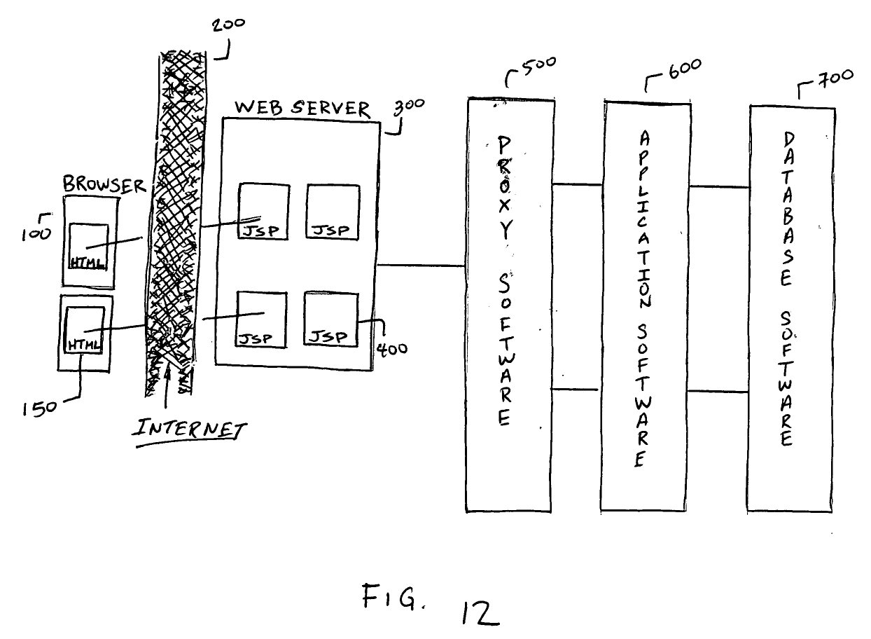

FIG. 12. details the mid level view of the web architecture associated with the said invention. There exists a [100] internet browser software which displays user interfaces in [150] Hyper Text Markup Language. Interfaces provide users the ability to input data into the system and read information from the system. HTML interfaces are generated by [400] Java Server Pages residing on the [300] web server software. The Java Server Pages processes the incoming messages to the [500] proxy software layer and generates the corresponding HTML to be displayed on the internet browser software. The proxy layer forwards the requests for further processing to the [600] application layer. The application layer holds a constant connection to a [700] database software where associated data can be saved and retrieved at a later time. All communications traveling from the internet browser software to the database software occurs in real time but may be subject to latencies when traversing the
internet.

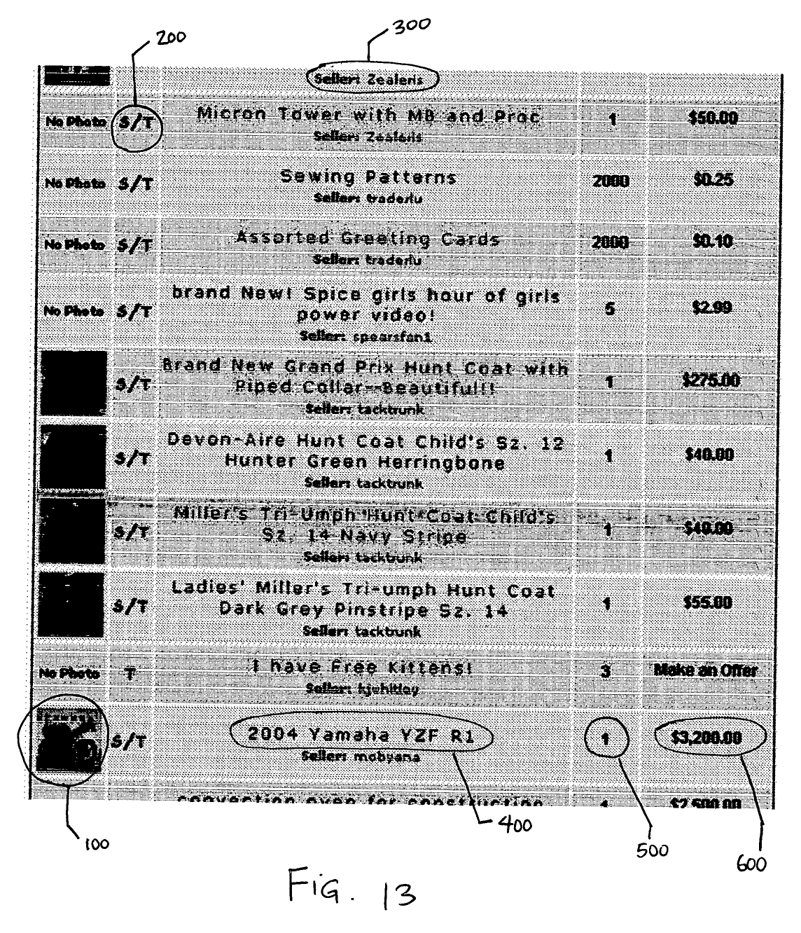

FIG. 13 details the interface component of search results when a user searches a central database for items that are available for exchange. [100] Thumbnails are generated from available photos and displayed for items advertised for exchange. [200] Trade indicator, specifying whether an item is for sale or for exchange or both. [300] The member name of the seller is displayed with the associated item. [400] The title of the item being advertised for exchange. [500] Quantity of the items for exchange. [600] Estimated price for the advertised item.

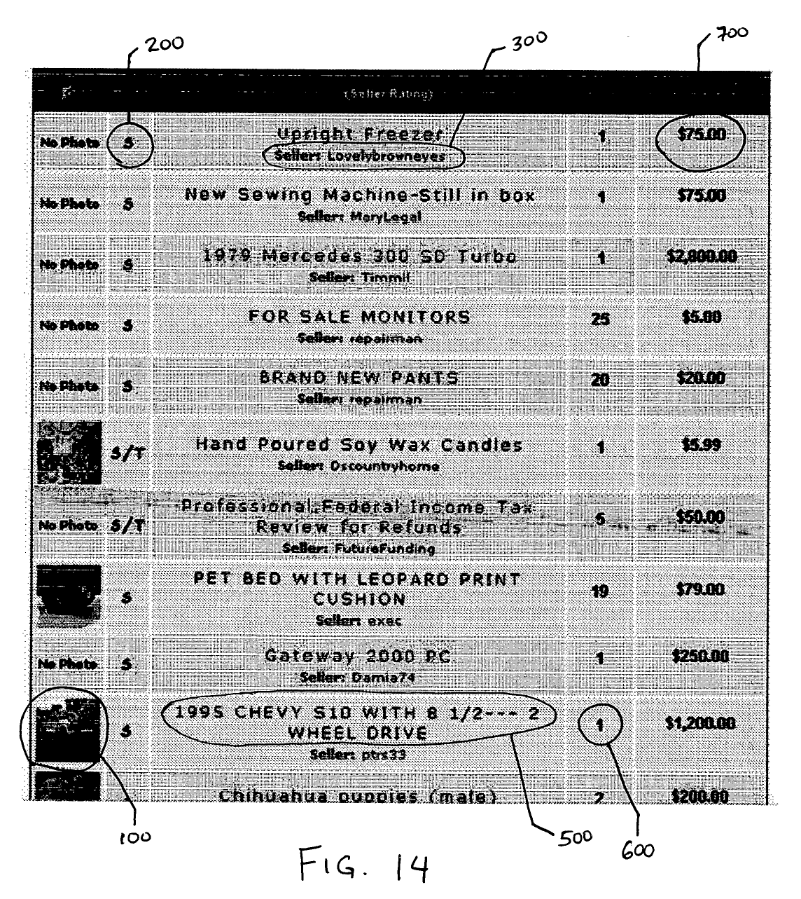

FIG. 14 details the interface component of search results when a user searches a central database for items that are available for sale. [100] Thumbnails are generated from available photos and displayed for items advertised for sale. [200] Trade indicator, specifying whether an item is for sale or for exchange or both. [300] The member name of the seller is displayed with the associated item. [500] The title of the item being advertised for sale. [600] Quantity of the items for sale. [700] Asking price for the advertised item.

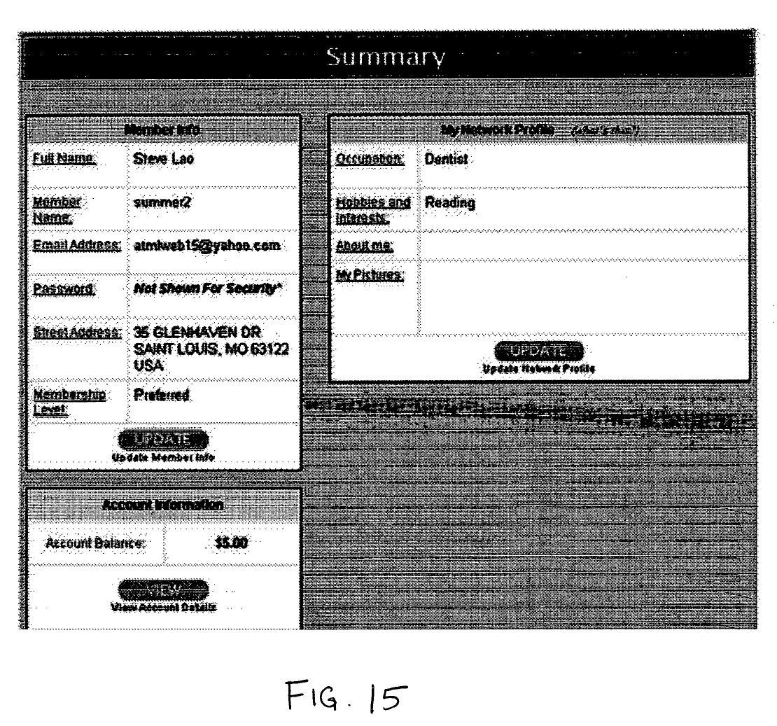

FIG. 15 details the interface component of the profile information for a specific user. The HTML page is generated after searching the database for the data associated with a user. The information retrieved includes customer information, account information, inventory information, message information and user profile information. All information will be formatted and displayed by the JSP component of the invention to be viewed by a client computer containing internet browser software.

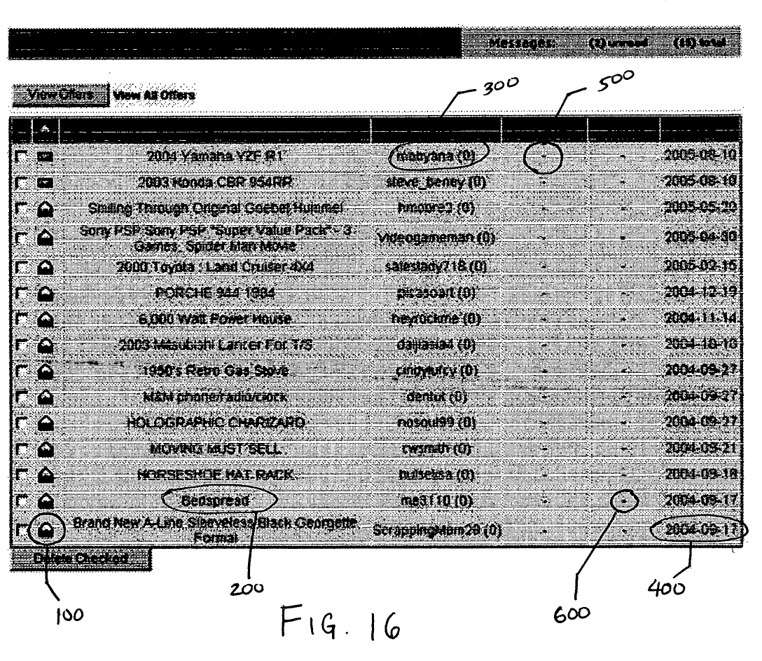

FIG. 16 details the interface component of user messages associated with the purchase or offers in currency for items advertised, where advertised items are not associated with the said buyer. [100] Picture display represents the status of a message. The different statuses each have a corresponding picture. Read and unread are represented with a corresponding open and closed envelope. [200] Subject is displayed for each message. Subject of message would be the title of the associated advertised item. [300] Seller member name is displayed next to the message subject. [400] Date of the message is displayed next to the seller member name. [500] Last offer price is displayed next to seller member name. [600] Status of the offer is displayed next to the last offer price.

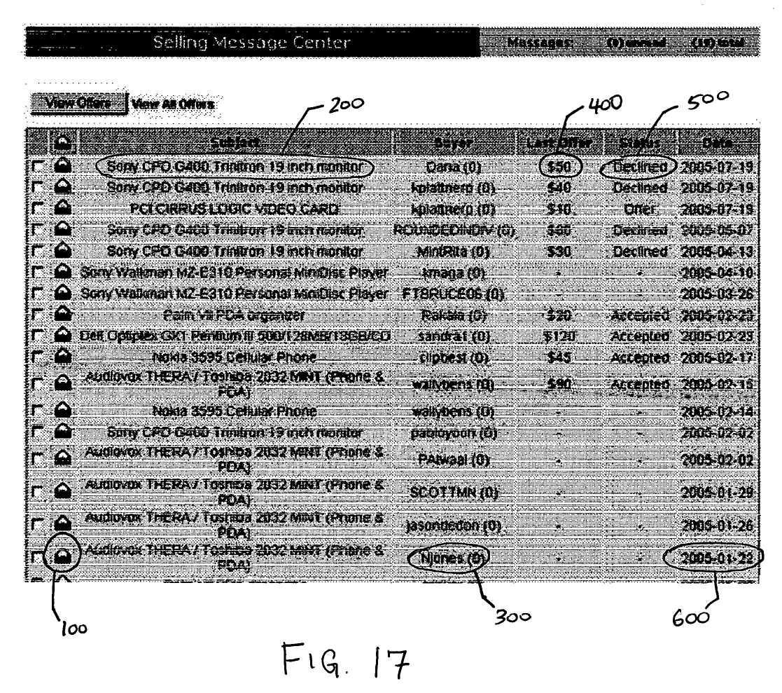

FIG. 17. details the interface component of user messages associated with the sale or offer in currency for items advertised, where advertised item is associated with the said user. [100] Picture display represents the status of a message. The different statuses each have a corresponding picture. Read and unread are represented with a corresponding open and closed envelope. [200] Subject is displayed for each message. Subject of a message would be the title of the associated advertised item. [300] Seller member name is displayed next to the message subject. [600] Date of the message is displayed next to the offer status. [400] Last offer price is displayed next to seller member name. [500] Status of the offer is displayed next to the last offer price.

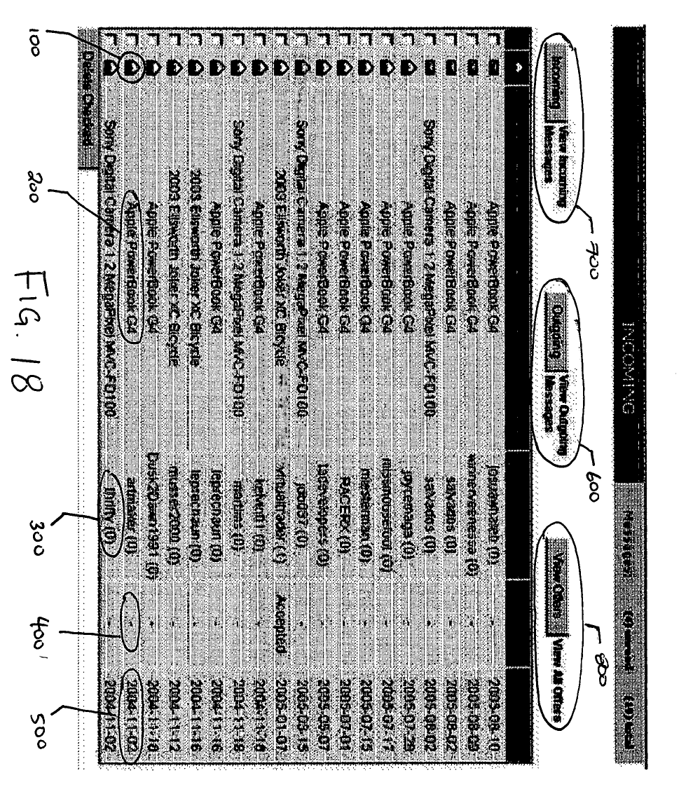

FIG. 18 details the interface component of user messages associated with the exchange or offers made, using a good, service or plurality of goods and services for items advertised, wherein the advertised items can be associated with the said user or not be associated with the said user. [100] Picture display represents the status of a message. The different statuses each have a corresponding picture. Read and unread are represented with a corresponding open and closed envelope. [200] Subject is displayed for each message. Subject of message would be the title of the associated advertised item. [300] Seller member name is displayed next to the message subject. [500] Date of the message is displayed next to the seller member name. [400] Status of the offer is displayed next to the last offer price. [600] Displays associated outgoing messages created by the said user. [700] Displays associated incoming messages not created by the associated user. [800] Searches central database for said user associated offers and displays to browser software.

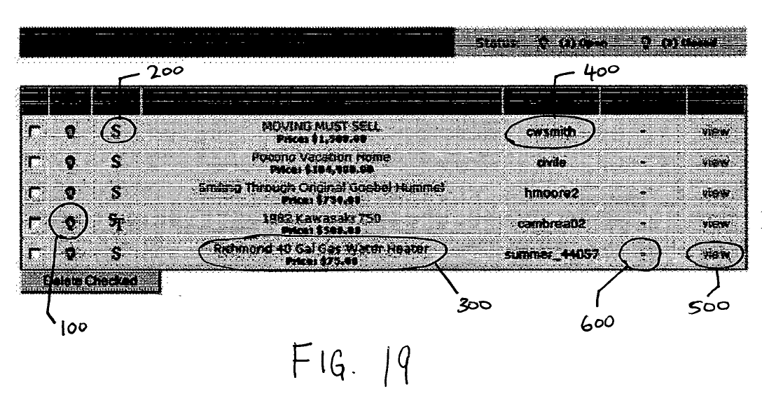

FIG. 19 details the interface component of a want list of advertised items available for sale, saved to a central database. [100] Picture indicates whether advertised item is active or inactive. [200] Picture indicates whether an advertised item is for sale, for exchange or both. [300] The title of the advertised item. [400] The member name of the seller associated with an advertised item.

The date the associated advertised item will expire and no longer be available to purchase. [600] Link to view all advertised items from a particular associated seller.

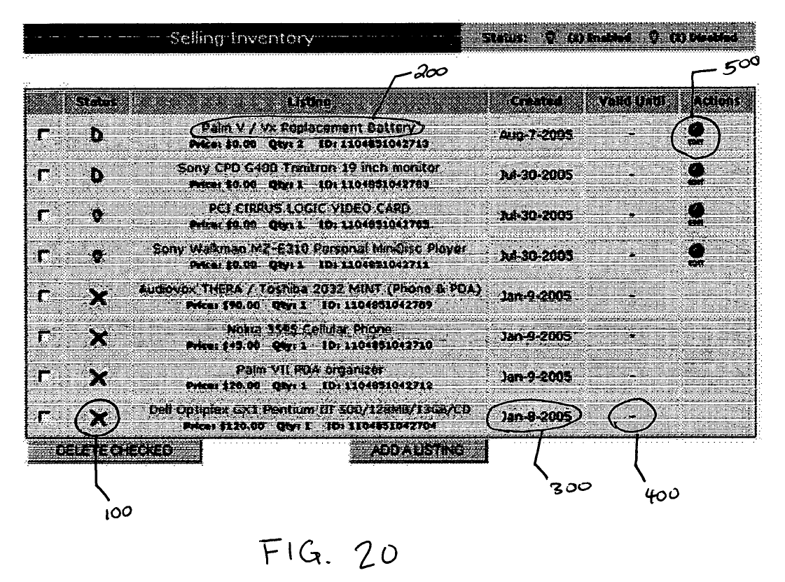

FIG. 20. details the interface component of an inventory of advertised items for sale of an associated user. [100] Pictures indicate the status of the advertised item. Statuses could be active, declined, pending, sold and offered.

Title is displayed for each saleable item. [300] Date of creation for the associated advertisement. [400] Date the associated advertisement will expire and no longer be searchable. [500] Edit link to modify the details of the associated advertisement.

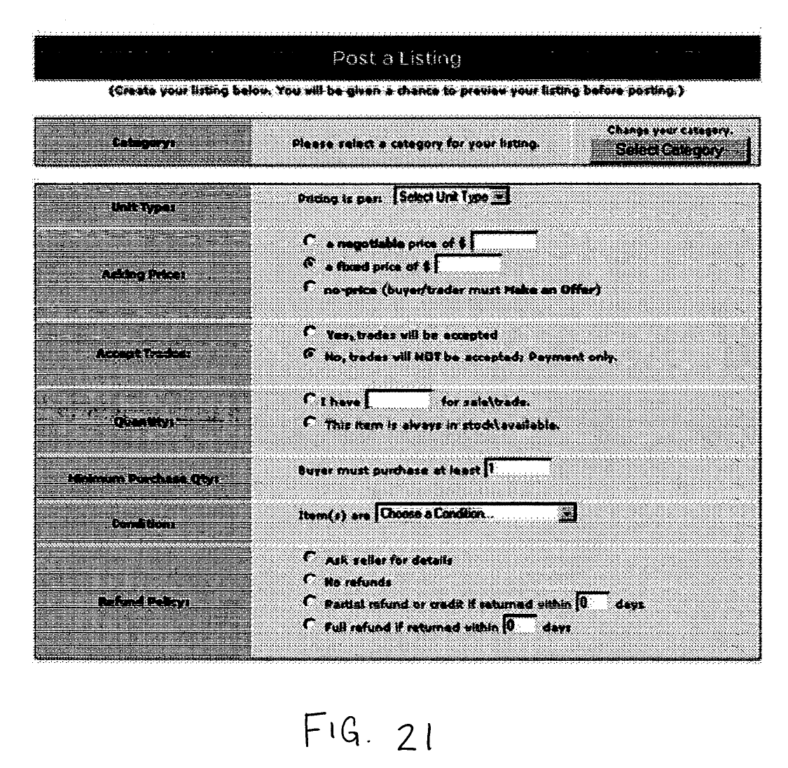

FIG. 21 details the interface component of adding a sales advertisement for an item to a central database. Input fields capture information associated with the item including category, price, unit type, trade type, quantity, condition, tax, refund policy, title, item description, photos and shipping information.

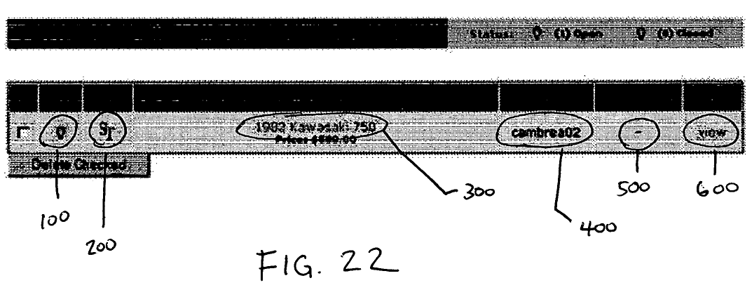

FIG. 22 details the interface component of a want list of advertised items available for exchange, saved to a central database. [100] Picture indicates whether advertised item is active or inactive. [200] Picture indicates whether an advertised item is for sale, for exchange or both. [300] The title of the advertised item. [400] The member name of the seller associated with an advertised item. [500] The date the associated advertised item will expire and no longer be available to purchase. [600] Link to view all advertised items from a particular associated seller.

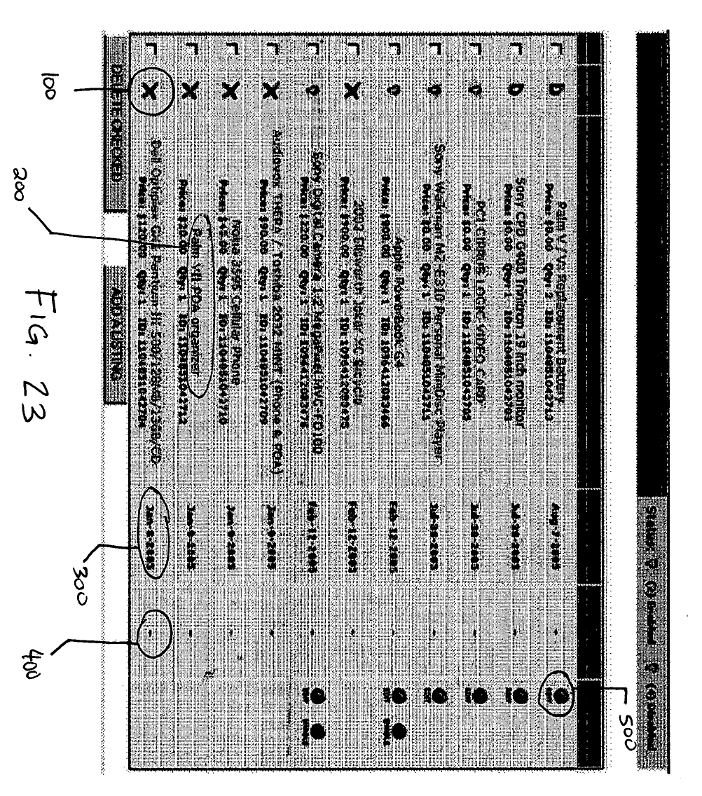

FIG. 23. details the interface component of an inventory of advertised items for exchange of an associated user. [100] Pictures indicate the status of the advertised item. Statuses could be active, declined, pending, sold and offered. [200] Title is displayed for each exchangeable item. [300] Date of creation for the associated advertisement. [400] Date the associated advertisement will expire and no longer be searchable. [500] Edit link to modify the details of the associated advertisement.

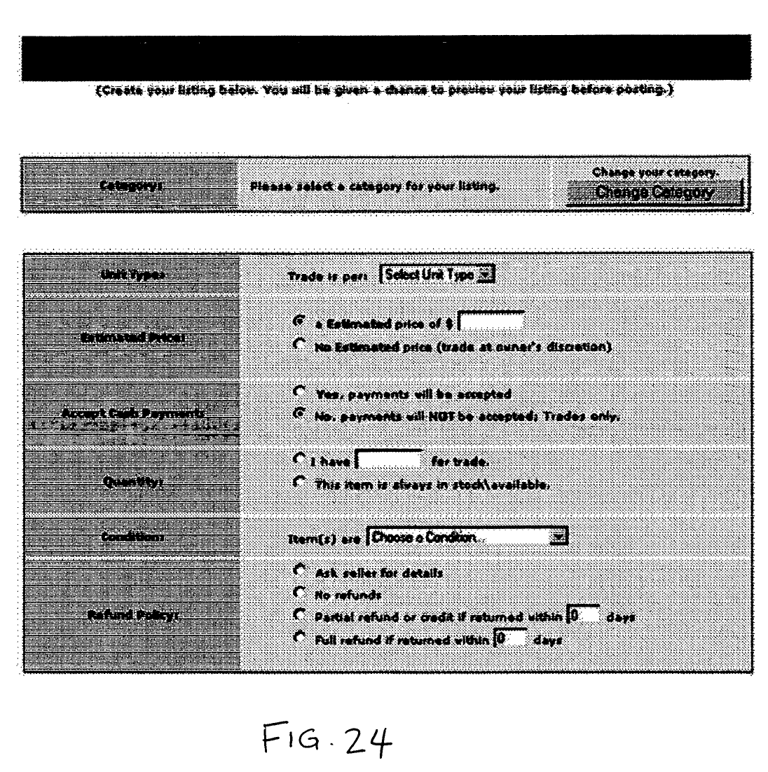

FIG. 24 details the interface component of adding an exchange advertisement for an item to a central database. Input fields capture information associated with the item including item category, exchange category, price, unit type, trade type, quantity, condition, tax, refund policy, title, item description, photos and shipping information.

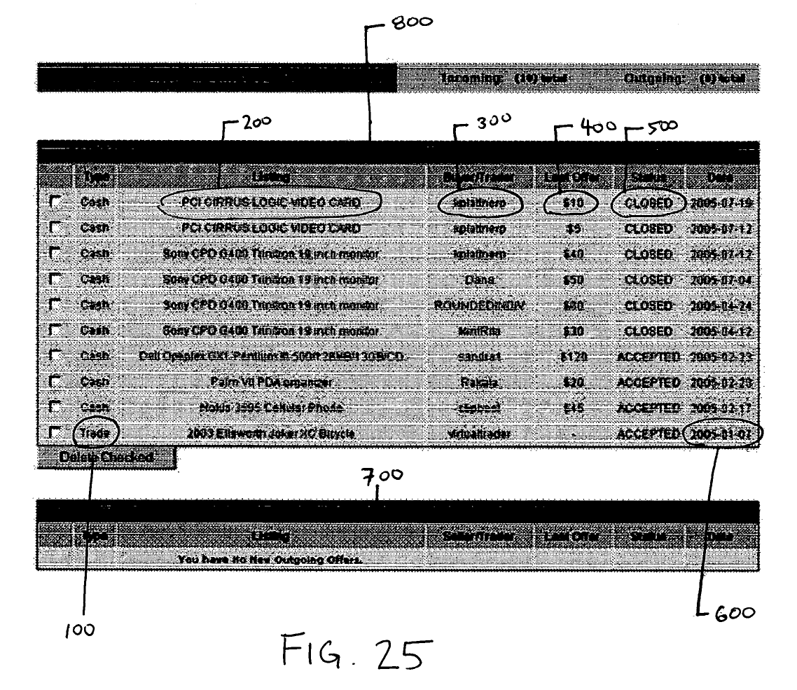

FIG. 25 details the interface component of displaying offers associated with a particular user. [100] Trade type displays the type of offer. Trade type can be a currency offer or an exchange offer, in a currency offer, payment is made using currency and in an exchange offer, payment is made with goods or services. [200] Display title of item in which offer is associated with. [300] Display of user name of a user who is associated with the offer. [400] Display of last offer price. [500] Display of status of an associated offer. Statuses can be open, closed or negotiating. [600] Display the date the associated offer was made. [700] This section contains offers made for an advertised item associated with the said user. [800] This section contains offers made by the said user for advertised items that are not associated with the said user.

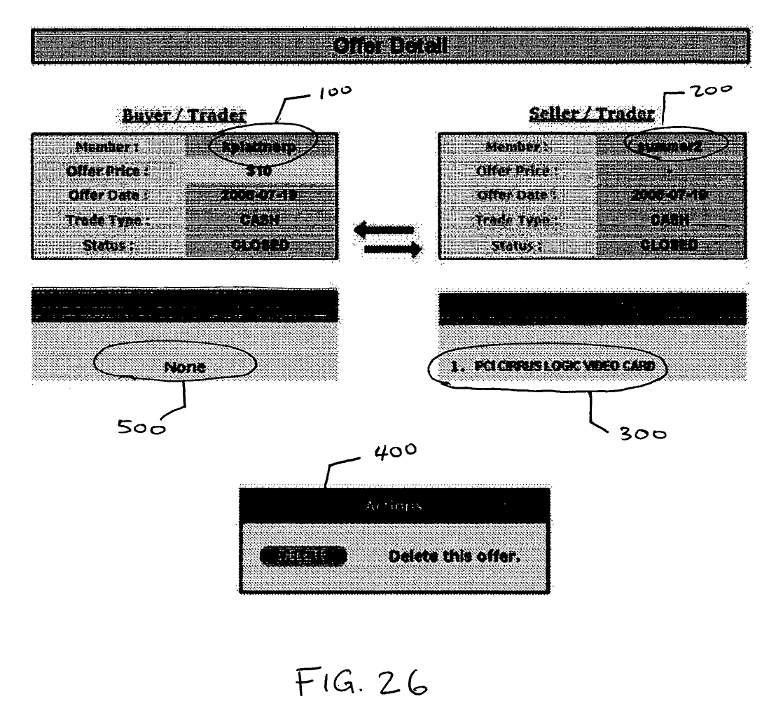

FIG. 26 details the interface component of a specific offer associated with an item. [100] Display user name of user creating this offer. [200] Display of user name of user who is associated with the advertised item. [300] Advertised item that offer is being made for. [500] Items or services offered as payment for the advertised item. [400] Action buttons to allow a user to complete the transaction. Buttons can display actions depending on the role of a specified user. Button actions include accept, decline, view, note and delete.

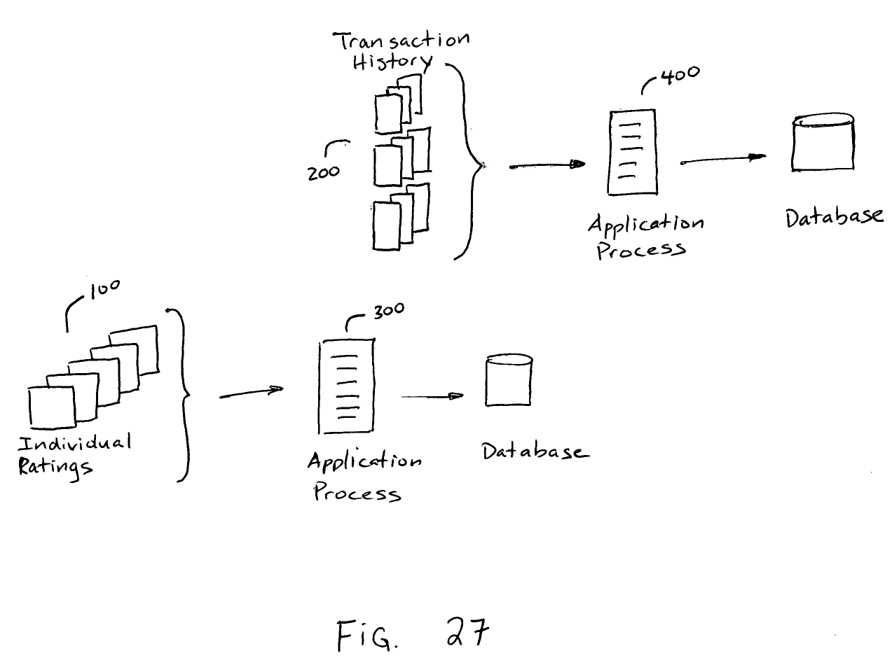

FIG. 27 details the architecture of the ratings and history components of the invention. [100] Individual ratings are collected after each transaction from both users of a transaction. Ratings input include answering 5 ratings question, selecting a ratings score and entering comments about the transaction. [200] The collected ratings data will be aggregated with the previous ratings data of the users. Ratings score will be summarized and calculated based on a value system. Positive ratings will have value of 1, negative ratings will have value of −1 and neutral ratings will have value of 0. All aggregated data will be saved in a central database for later retrieval. [200] A transaction history will exist upon completion of a transaction. All transaction histories are calculated and aggregated based on time. Calculations will be made for the number of transaction over a past week, a past month, a past 6 months and a past year. [400] All aggregated data will be saved in a central database for later retrieval.

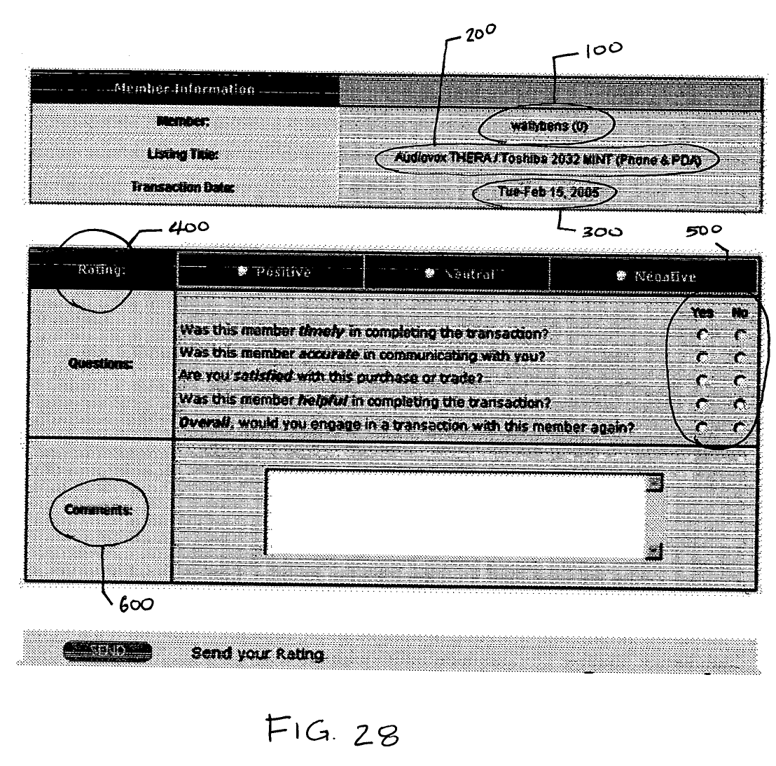

FIG. 28 details the interface component of a ratings input interface associated with a specific transaction. [100] User name of user involved in the completed transaction. [200] The advertised item that is associated with the completed transaction. [300] The date the transaction was completed. [400] Input for rating the transaction based on a value system. Ratings selected can be positive, negative and neutral. [500] Question regarding the completed transaction which are to be aggregated with the ratings history of the said user. [600] Input for comments about this transaction.

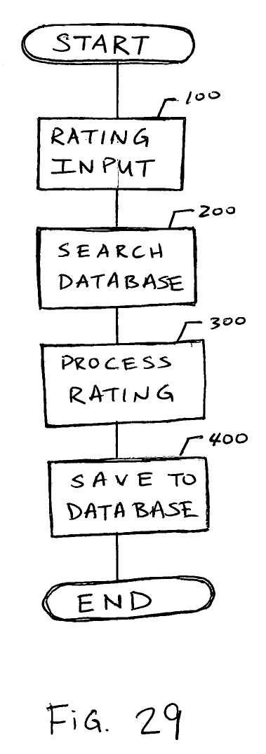

FIG. 29 details the flow by which a rating is processed. [100] Upon completing a transaction, a user involved in a transaction can input feedback on the other user associated with the transaction and the transaction overall. [200] Search of a central database to retrieve all ratings and history data for the said associated user being rated. [300] Newly inputted ratings data will be aggregated to the retrieved ratings data in order to calculate new ratings values. New transaction data will be aggregated to the retrieved transaction data in order to calculate new transaction values. Aggregated values include a ratings score, questionnaire score, transaction totals and user comments. [400] Calculated values will be stored to a central database for later retrieval.

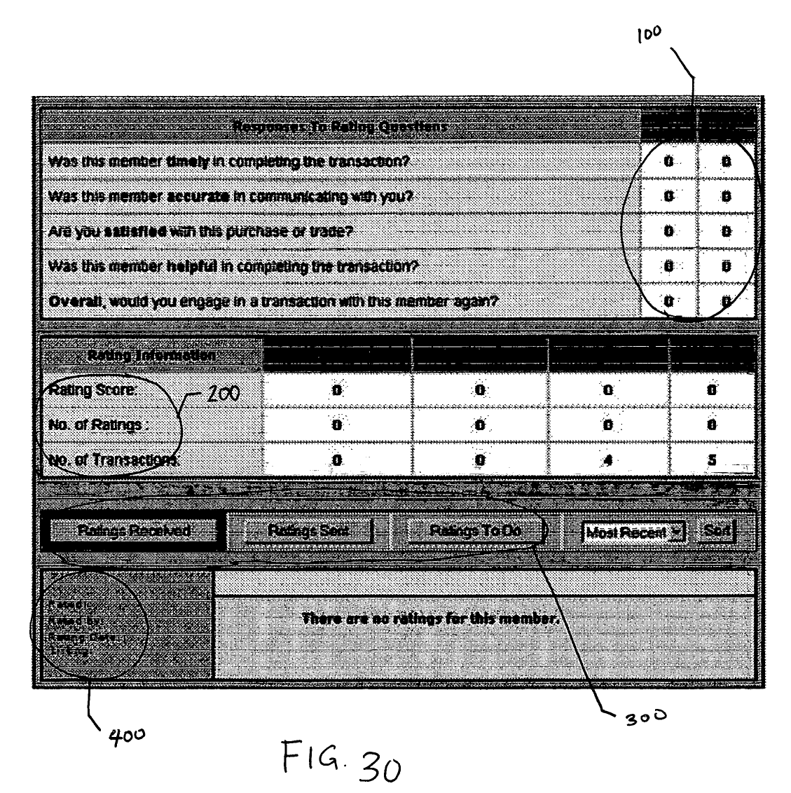

FIG. 30 details the interface component of a ratings display associated with a specific user. [100] Display of the aggregated ratings score for the questionnaire feedback totals. [200] Display the total ratings score and summary of ratings and transactions. Aggregate ratings will be displayed based on time, including past week, past month, past 6 months and past year. [300] Selection to view associated ratings history based on ratings being sent, ratings being received or ratings that are not yet complete. [400] Details of a transaction being rated and comment left by the user associated with the said transaction.

What is claimed:

1) the system and method for exchanging an item or plurality of items between two users over a communications network such as the internet, the said method comprising:
registering users to the system
creating a data profile of the said item
saving an item associated with a registered user to a central database
items are subjected to approval by a super user before being searchable by other users
searching a database based on item criteria
begin an exchange between two users
negotiating an exchange between two users
completing an exchange between two users
process a payment for the completion of a transaction

2) The method of claim 1, further comprising the capture of personal user information, financial user information and assigning a unique identifier associated with the said user.

3) The method of claim 1, further comprising the capture of information related to a good or service to be inputted by the said user.

4) The method of claim 1, further comprising of a search for item, items and associated data from a central database based on the criteria of the associated item, items or data, search result lists items which are then each assigned a status by a super user, assigned status would enable the said item to be searchable by other users.

5) The method of claim 1, further comprising of a search of a central database, search criteria based on one or more table columns, resulting in a list of items and associated data that is available for exchange or available for sale.

6) The method of claim 1, further comprising of an exchange of electronic notes, between a first user and a second user, electronic notes are to be associated with an item, the said item is associated with the first said user or the second said user, electronic notes are to be exchanged during, prior or after engaging in a transaction.

7) The method of claim 1, further comprising of beginning and ending a transaction between two users, whereby a complete transaction takes place and item or items associated with the said users are claimed and removed from public display, personal information associated with both users are then exchanged.

8) The method of claim 1, further comprising of beginning a transaction between two users, whereby a offer in currency is created by the first user for an item or plurality of items associated with the second user, offers can be accepted or rejected by the second user, thereby ending and completing the transaction.

9) The method of claim 1, further comprising of beginning a transaction between two users, where an offer in goods or services is created by the first user for an item or plurality of items associated with the second user, offers can be accepted or rejected by the second user, thereby ending and completing the transaction.

10) The method of claim 1, further comprising the ending of a transaction between two users, where as the offer for an item has been accepted or rejected and the transaction becomes complete, all open transactions associated with the items in the said accepted transaction which are not complete will be completed, electronic messages will be sent to users associated with the completed transactions. All item or items associated with the completed transactions will be removed or added to the display and all completed transactions will be saved to the central database.

11) The method of claim 1, further comprising the payment of associated fees relating to the completion of a transaction, where by payment is made using financial data that can be inputted by a user or associated financial data that may already exist in the central database.

12) Method and apparatus to convert system information and data into a format displayable by internet browser software and to convert input or collected data from internet browser software into a format that is readable or collectable by a computer system for the sole purpose of implementing a system for exchange, the said method comprising:
Displaying database items pertaining to exchangeable items using an internet browser software
Displaying database items pertaining to saleable items using an internet browser software
Displaying information associated with a unique user using internet browser software
Displaying electronic messages and capturing an electronic message input for items, wherein the said items are not associated with the said user and wherein the said items are categorized as sale, using internet browser software.
Displaying electronic messages and capturing an electronic message input for items, wherein the said items are categorized as sale and wherein the said items are associated with the said user, using internet browser software.
Displaying electronic messages and capturing electronic message input for items, wherein the said items are categorized as exchange, wherein the said items are not associated with the said user, using internet browser software
Displaying electronic messages and capturing electronic message input for items, wherein the said items are categorized as exchange, wherein the said items are associated with the said user, using internet browser software
Displaying and capturing item or items that is to be bookmarked for purchase at a later time
Displaying an item or plurality of items and associated item information, wherein item or items displayed are to be used in a transaction where payment will be made using currency.
Interface to capture user input for the insertion of item or items to be used in a transaction where payment will be made in currency, wherein item or items are saved into a central database
Displaying and capturing item or items that are bookmarked for exchange at a later time
Displaying an item or plurality of items and associated item information, wherein item or items displayed are to be used in a transaction where payment will be made using the said item or items.
Interface to capture user input for the insertion of item or items to be used in a transaction where payment will be made using the said item, wherein item or items are saved into a central database
Interface to display data and information associated with a negotiation or plurality of negotiations involving the said user
Interface to display data and information associated with a negotiation of a specific item or plurality of items involving the said user

13) The computer implemented system of claim 12, wherein the display component searches a central database based on exchangeable status or saleable status and displays the results from the search on said browser software.

14) The computer implemented system of claim 12, wherein the display component searches a central database based on a unique user identifier and displays associated user information on said browser software.

15) The computer implemented system of claim 12, wherein the display component searches a central database based on a unique user identifier and displays messages associated with purchases, sales or exchanges on said browser software.

16) The computer implemented system of claim 12, wherein the display component searches a central database based on a unique user identifier and displays items saved from a previous search, resulting in items available for bid or exchange.

17) The computer implemented system of claim 12, wherein the display component searches a central database based on a unique user identifier and displays items associated with the said user where said items are available for sale or said items are available for exchange.

18) The computer implemented system of claim 12, wherein the input component captures data pertaining to an item, wherein the said item is searchable from a central database, wherein searches made to the central database results in saleable items or exchangeable items.

19) The computer implemented system of claim 12, wherein the display component captures data and displays information pertaining to one or more completed or incomplete exchanges between a said user and associated or non associated items.

20) Interface and method to capture and display rating data and transaction history associated with a said user, where in captured data is aggregated and saved in a central database and displayed using internet browser software, the said method comprising:
interface to capture rating data, wherein data is to be stored on a central database
process of aggregating and calculating rating and transaction data, wherein data is saved in a central database
convert rating and transaction data into format displayable using a internet browser software
